(19) United States
(12) Patent Application Publication
(10) Pub. No.: US 2024/0243604 A1
(43) Pub. Date: Jul. 18, 2024

(54) POWER CONVERSION CIRCUIT AND CONTROL METHOD THEREOF, BATTERY PACK, AND ENERGY STORAGE SYSTEM

(71) Applicant: Huawei Digital Power Technologies Co., Ltd., Shenzhen (CN)

(72) Inventors: Siwei YANG, Dongguan (CN); Haibin GUO, Dongguan (CN); Shaohui ZHONG, Shenzhen (CN); Yuandong MENG, Shanghai (CN)

(73) Assignee: Huawei Digital Power Technologies Co., Ltd., Shenzhen (CN)

(21) Appl. No.: 18/413,345

(22) Filed: Jan. 16, 2024

(30) Foreign Application Priority Data
Jan. 16, 2023 (CN) 202310104820.4
Apr. 21, 2023 (CN) 202310456121.6

(51) Int. Cl. H02J 7/04; H02M 1/088; H02M 3/335

(52) U.S. Cl. CPC H02J 7/04; H02M 1/088; H02M 3/33573; H02M 3/33584; H02J 2207/20

(57) ABSTRACT

A power conversion circuit includes a controller, a first-level DC/DC conversion circuit, a plurality of second-level DC/DC conversion circuits, a switching module, a first capacitor, a plurality of second capacitors, and a battery. When a voltage of the battery is less than a first voltage threshold and voltages of the first capacitor and the second capacitor are less than a third voltage threshold, the controller controls the switching module to be turned off or turned on, so that the plurality of second-level DC/DC conversion circuits are connected in series; or when the voltage of the battery is greater than a second voltage threshold and voltages at two ends of the first capacitor and the second capacitor are less than the third voltage threshold, the controller controls the switching module to be turned off or turned on, so that the plurality of second-level DC/DC conversion circuits are connected in parallel.

### CROSS-REFERENCE TO RELATED APPLICATIONS

This application claims priority to Chinese Patent Application No. 202310456121.6, filed on Apr. 21, 2023 and Chinese Patent Application No. 202310104820.4, filed on Jan. 16, 2023. Both of the aforementioned applications are hereby incorporated by reference in their entireties.

### TECHNICAL FIELD

The embodiments relate to the field of electronic technologies, and to a power conversion circuit and a control method thereof, a battery pack, and an energy storage system.

### BACKGROUND

An energy storage system is a device used to store energy, and may be applied to the field of photovoltaic power generation. For example, the energy storage system can receive, through a power supply circuit, an input voltage provided by a power generation device such as a photovoltaic panel, process the input voltage, and then provide an output voltage to an energy storage device such as a battery. The battery stores electric energy provided by the output voltage. The energy storage system may also supply power to another electrical device by using the electric energy stored in the energy storage system.

In the conventional technology, when a power generation device is affected by an external condition, a voltage value of an input voltage provided to an energy storage system is unstable. For the energy storage system, when different input voltages are received, the power supply circuit may adjust, by adjusting a turn-on frequency and a turn-off frequency of a switching transistor, a voltage value of an output voltage provided by the power supply circuit for the battery, so as to ensure stable and reliable energy transfer.

For example, the energy storage converter system includes a DC/DC conversion circuit that boosts a battery voltage to a normal operating voltage range and an inverter circuit that converts a direct current output by the DC/DC conversion circuit into an alternating current. To adapt to a requirement of a wide voltage operating range of an inverter, a range of a boost ratio of the DC/DC conversion circuit is relatively wide, and system efficiency is relatively reduced when the boost ratio is very high. In this case, a series/parallel connection manner between a plurality of DC/DC conversion circuits needs to be switched. Generally, output capacitors are connected in parallel at two ends of the DC/DC conversion circuit to stabilize voltages at two ends of the DC/DC conversion circuit. When a series/parallel connection operating mode of the DC/DC conversion circuit is directly switched, a sudden voltage change occurs on the output capacitor, thereby generating a high current, which easily causes contact adhesion of a switching switch. In addition, current impact caused by the sudden voltage change may easily damage a component or a load connected to the DC/DC conversion circuit.

### SUMMARY

The embodiments provide a power conversion circuit and a control method to resolve a problem that a voltage of a capacitor may suddenly change due to series/parallel connection of a direct current output circuit, so as to ensure safe switching, improve electric energy conversion efficiency of a system, and reduce costs because no circuit component needs to be added.

According to a first aspect, an embodiment provides a power conversion circuit, where the power conversion circuit includes a controller, a first-level DC/DC conversion circuit, a plurality of second-level DC/DC conversion circuits, and a switching module. A first end of the first-level DC/DC conversion circuit is configured to connect to an external device, a second end of the first-level DC/DC conversion circuit is connected to a first end of the switching module, a first end of each second-level DC/DC conversion circuit is connected to a second end of the switching module, and a second end of each second-level DC/DC conversion circuit is configured to connect to a battery; one first capacitor is connected in parallel to the first-level DC/DC conversion circuit, and the first capacitor is configured to stabilize a voltage of the first-level DC/DC conversion circuit; and one second capacitor is connected in parallel to each second-level DC/DC conversion circuit, and the second capacitor is configured to stabilize a voltage of a corresponding second-level DC/DC conversion circuit that is connected. The controller is configured to: when a voltage of the battery is less than a first voltage threshold and voltage values of the first capacitor and the second capacitor are less than a third voltage threshold, control the switching module to be turned off or turned on, so that the plurality of second-level DC/DC conversion circuits are connected in series; or when the voltage of the battery is greater than a second voltage threshold and the voltage values of the first capacitor and the second capacitor are less than the third voltage threshold, control the switching module to be turned off or turned on, so that the plurality of second-level DC/DC conversion circuits are connected in parallel. The power conversion circuit changes a voltage of a second port of the first-level DC/DC conversion circuit by switching the series/parallel connection manner between the plurality of second-level DC/DC conversion circuits, so as to change a boost ratio of the first-level DC/DC conversion circuit, improve electric energy conversion efficiency of a system, and avoid damage to a switch or a component connected to the switch due to a sudden voltage change of the first capacitor and the second capacitor when the series/parallel connection manner between the plurality of second-level DC/DC conversion circuits is switched, thereby ensuring safe switching.

In a possible implementation, the controller is further configured to: when the voltage of the battery is less than the first voltage threshold or when the voltage of the battery is greater than the second voltage threshold, adjust a pulse width modulation (PWM) signal of the first-level DC/DC conversion circuit to reduce voltage values of the first capacitor and the second capacitor to be less than the third voltage threshold. According to the power conversion circuit provided, control logic for adjusting the voltage values of the first capacitor and the second capacitor is simple, and no circuit component needs to be added, thereby reducing costs and shortening a switching time.

In a possible implementation, the controller is configured to control, before the controller adjusts the PWM signal of the first-level DC/DC conversion circuit, each second-level DC/DC conversion circuit to stop operating.

In a possible implementation, the controller is further configured to: after adjusting the PWM signal of the first-level DC/DC conversion circuit to reduce the voltage values of the first capacitor and the second capacitor to be less than the third voltage threshold, control the first-level DC/DC conversion circuit to stop operating, so as to ensure that the entire circuit stops operating when the series/parallel connection manner between the plurality of second-level DC/DC conversion circuits is switched, thereby ensuring safe switching.

In a possible implementation, the controller is further configured to: after the first-level DC/DC conversion circuit stops operating, control the switching module to be turned off or turned on, so that the plurality of second-level DC/DC conversion circuits are connected in series or in parallel, a time of the entire switching process is short, and the entire loop stops operating during switching, thereby ensuring safe switching.

In a possible implementation, when the battery is in a charging state, the first-level DC/DC conversion circuit is configured to reduce a voltage of a first port of the first-level DC/DC conversion circuit, and the second-level DC/DC conversion circuit is configured to reduce a voltage of a first port of the second-level DC/DC conversion circuit to a charging voltage required by the battery, so as to charge the battery. When the battery is in a discharging state, the second-level DC/DC conversion circuit is configured to boost a voltage of a second port of the second-level DC/DC conversion circuit, and the first-level DC/DC conversion circuit is configured to boost a voltage of a second port of the first-level DC/DC conversion circuit and output the boosted voltage to an external device through the first port of the first-level DC/DC conversion circuit. The power conversion circuit may be applied to both a battery charging scenario and a battery discharging scenario, to implement bidirectional conversion of electric energy. The power conversion circuit may be used in a wide range of scenarios, thereby improving application flexibility of the power conversion circuit.

In a possible implementation, the power conversion circuit further includes a detection circuit. The detection circuit is configured to detect a voltage value of the battery and voltage values of the first capacitor and the second capacitor, to accurately detect a charging/discharging voltage of the battery, and accordingly change a series/parallel connection manner between the plurality of second-level DC/DC conversion circuits, so as to change the voltage of the second port of the first-level DC/DC conversion circuit, change a boost ratio on both sides of the first-level DC/DC conversion circuit, and improve electric energy conversion efficiency of the system. The power conversion circuit accurately detects the voltages of the first capacitor and the second capacitor, to ensure that the voltages of the first capacitor and the second capacitor are less than the third voltage threshold during series/parallel switching and are reduced to be less than a safe operating voltage, thereby preventing a component from being damaged due to a high current generated by a sudden voltage change, and ensuring safe switching.

Composition of the switching module is not limited in this embodiment. For example, the switching module may include a relay, a metal-oxide-semiconductor (MOS) transistor, or an insulated gate bipolar transistor (IGBT).

In a possible implementation, the switching module includes a relay. The relay includes a plurality of contacts, and the plurality of contacts are connected to corresponding ports on the plurality of second-level DC/DC conversion circuits. A series/parallel connection manner between the plurality of second-level DC/DC conversion circuits is switched by switching connections between the relay and different ports. Control logic is simple, and a circuit architecture is simple, and no circuit component needs to be added, thereby reducing costs.

In a possible implementation, the switching module includes a plurality of MOS transistors. The plurality of MOS transistors are connected to corresponding ports on the plurality of second-level DC/DC conversion circuits, and the series/parallel connection manner between the plurality of second-level DC/DC conversion circuits is switched by switching connections between the MOS transistors and different ports. Control logic is simple, a circuit architecture is simple, and costs are reduced because no circuit component needs to be added. In addition, the MOS transistors have a short switching time, and can implement quick switching of the series/parallel connection manner between the plurality of second-level DC/DC conversion circuits, thereby improving operating efficiency of the system.

In a possible implementation, the switching module includes a plurality of IGBTs. A plurality of IGBTs are connected to corresponding ports on a plurality of second-level DC/DC conversion circuits, and a series/parallel connection manner between the plurality of second-level DC/DC conversion circuits is switched by switching connections between the IGBTs and different ports. Control logic is simple, a circuit architecture is simple, and no circuit component needs to be added, thereby reducing costs. The IGBT has advantages of a low saturation voltage drop, high current-carrying density, and low drive power, thereby improving operating efficiency of the system.

In a possible implementation, the first-level DC/DC conversion circuit is a Buck-Boost circuit, and the second-level DC/DC conversion circuit is an LLC conversion circuit. When the battery is in a charging state, the Buck-Boost circuit is configured to reduce a voltage of a first port of the Buck-Boost circuit, and the LLC conversion circuit is configured to reduce a voltage of a first port of the LLC conversion circuit to a charging voltage required by the battery. When the battery is in a discharging state, the LLC conversion circuit is configured to boost a voltage of the battery, and the Buck-Boost circuit is configured to boost a voltage of a second port of the Buck-Boost circuit and then output the boosted voltage to an external device. The LLC conversion circuit has a simple structure, and generally includes components such as a switching transistor, a transformer, a capacitor, and an inductor. The LLC conversion circuit has a small size and has a high power density, thereby improving electric energy conversion efficiency of the system.

In a possible implementation, the first-level DC/DC conversion circuit is a Buck-Boost circuit, and the second-level DC/DC conversion circuit is a dual-active bridge conversion circuit. When the battery is in a charging state, the Buck-Boost circuit is configured to reduce a voltage of a first port of the Buck-Boost circuit, and the dual-active bridge conversion circuit is configured to reduce a voltage of a second port of the dual-active bridge conversion circuit to a charging voltage required by the battery. When the battery is in a discharging state, the dual-active bridge conversion circuit is configured to boost a voltage of the battery, and the Buck-Boost circuit is configured to boost a voltage of the second port of the Buck-Boost circuit and output the boosted voltage to an external device. The dual-active bridge conversion circuit has advantages such as high conversion efficiency, a high power density, low voltage stresses and current stresses of power devices, and easy implementation, a simple structure, and easy integration of a soft switch, which improves the electric energy conversion efficiency of the system.

In a possible implementation, the power conversion circuit includes a first-level DC/DC conversion circuit, two second-level DC/DC conversion circuits, a switching module, and a controller. A first end of the first-level DC/DC conversion circuit is configured to connect to an external device, a second end of the first-level DC/DC conversion circuit is connected to a first end of the switching module, a first connection point of the first-level DC/DC conversion circuit is connected to a first connection point of a second-level DC/DC conversion circuit A, a second connection point of the first-level DC/DC conversion circuit is connected to a second connection point of a second-level DC/DC conversion circuit B, and a second connection point of the second-level DC/DC conversion circuit A is connected to a second end of the switching module, a first connection point of the second-level DC/DC conversion circuit B is connected to a second end of the switching module. A second end of the second-level DC/DC conversion circuit A and a second end of the second-level DC/DC conversion circuit B are connected to a first end of the battery.

In a possible implementation, the external device is a direct current source, and the direct current source provides an output voltage to the battery through the power conversion circuit.

In a possible implementation, the external device is a load, and the battery provides a charging voltage to the load through the power conversion circuit.

In a possible implementation, the external device is an energy storage converter. The energy storage converter may provide an output voltage to the battery through the power conversion circuit, or may receive an output voltage of the battery through the power conversion circuit, to implement bidirectional conversion of electric energy.

According to a second aspect, the embodiments provide a control method for a power conversion circuit, where the power conversion circuit includes a controller, a first-level DC/DC conversion circuit, a plurality of second-level DC/DC conversion circuits, and a switching module; a first end of the first-level DC/DC conversion circuit is configured to connect to an external device, a second end of the first-level DC/DC conversion circuit is connected to a first end of the switching module, a first end of each second-level DC/DC conversion circuit is connected to a second end of the switching module, and a second end of each second-level DC/DC conversion circuit is configured to connect to a battery; one first capacitor is connected in parallel to the first-level DC/DC conversion circuit; and one second capacitor is connected in parallel to each second-level DC/DC conversion circuit. The control method includes: when a voltage of the battery is less than a first voltage threshold and a voltage value of a first capacitor and a voltage value of a second capacitor are less than a third voltage threshold, controlling the switching module to be turned off or turned on, so that the plurality of second-level DC/DC conversion circuits are connected in series; or when a voltage of a battery is greater than a second voltage threshold and a voltage value of a first capacitor and a voltage value of a second capacitor are less than a third voltage threshold, controlling the switching module to be turned off or turned on, so that the plurality of second-level DC/DC conversion circuits are connected in parallel. According to the control method, when series/parallel connection switching is performed on a plurality of second-level DC/DC conversion circuits, voltages of the first capacitor and the second capacitor are reduced, so that a high current is not caused by a sudden voltage change of each capacitor, and a switch or a component connected to each capacitor is not damaged. Control logic is simple, and a switching time is short, thereby improving electric energy conversion efficiency of a system.

In a possible implementation, the control method for a power conversion circuit further includes: when the voltage of the battery is less than the first voltage threshold or when the voltage of the battery is greater than the second voltage threshold, adjusting the PWM signal of the first-level DC/DC conversion circuit to reduce the voltage values of the first capacitor and the second capacitor to be less than the third voltage threshold, so as to ensure that the voltages at two ends of the first capacitor and the second capacitor are within a safe operating voltage range before the plurality of second-level DC/DC conversion circuits are switched, and avoid a sudden voltage change of the first capacitor and the second capacitor.

In a possible implementation, the control method for a power conversion circuit further includes: before the PWM signal of the first-level DC/DC conversion circuit is adjusted, controlling each second-level DC/DC conversion circuit to stop operating.

In a possible implementation, the control method for a power conversion circuit further includes: after adjusting the PWM signal of the first-level DC/DC conversion circuit to reduce the voltage values of the first capacitor and the second capacitor to be less than the third voltage threshold, control the first-level DC/DC conversion circuit to stop operating, so as to ensure that the entire circuit stops operating when the series/parallel connection manner between the plurality of second-level DC/DC conversion circuits is switched, thereby ensuring safe switching.

In a possible implementation, the control method for a power conversion circuit further includes: after the first-level DC/DC conversion circuit is controlled to stop operating, controlling the switching module to be turned off or turned on, so that the plurality of second-level DC/DC conversion circuits are connected in series or in parallel, a time of the entire switching process is short, and the entire loop stops operating during switching, thereby ensuring safe switching.

In a possible implementation, the control method for a power conversion circuit further includes: detecting a voltage value of the battery and voltage values of the first capacitor and the second capacitor. In this method, battery charging and discharging voltages are accurately detected, and a series/parallel connection manner between the plurality of second-level DC/DC conversion circuits is changed accordingly, so as to change a voltage of a second port of the first-level DC/DC conversion circuit, change a boost ratio on both sides of the first-level DC/DC conversion circuit, and improve electric energy conversion efficiency of the system. In the method, the voltages at two ends of the first capacitor and the second capacitor are further accurately detected, to ensure that the voltages of the first capacitor and the second capacitor are already less than a safe operating voltage during series/parallel switching, thereby preventing a component from being damaged due to a high current generated by a sudden voltage change, and ensuring safe switching.

According to a third aspect, the embodiments provide an energy storage apparatus, where the energy storage apparatus includes a battery, a controller, a first-level DC/DC conversion circuit, a plurality of second-level DC/DC conversion circuits, and a switching module. A first end of the first-level DC/DC conversion circuit is configured to connect to an external device, a second end of the first-level DC/DC conversion circuit is connected to a first end of the switching module, a first end of each second-level DC/DC conversion circuit is connected to a second end of the switching module, and a second end of each second-level DC/DC conversion circuit is connected to a battery; one first capacitor is connected in parallel to the first-level DC/DC conversion circuit; and one second capacitor is connected in parallel to each second-level DC/DC conversion circuit. The controller is configured to: when a voltage of the battery is less than a first voltage threshold and voltage values of the first capacitor and the second capacitor are less than a third voltage threshold, control the switching module to be turned off or turned on, so that the plurality of second-level DC/DC conversion circuits are connected in series; or when the voltage of the battery is greater than a second voltage threshold and the voltage values of the first capacitor and the second capacitor are less than the third voltage threshold, control the switching module to be turned off or turned on, so that the plurality of second-level DC/DC conversion circuits are connected in parallel. The energy storage apparatus includes two-level DC/DC conversion circuits. Two-level voltage conversion is performed on a voltage output by a power grid, and then the voltage is output to the battery, so that a voltage boost of the two-level DC/DC conversion circuits is relatively low, and operating efficiency of the energy storage apparatus is improved. A voltage of a second port of the first-level DC/DC conversion circuit is changed by switching the series/parallel connection manner between the plurality of second-level DC/DC conversion circuits, so as to change a boost ratio of the first-level DC/DC conversion circuit, improve electric energy conversion efficiency of the energy storage apparatus, and avoid damage to a switch or a component connected to the switch due to a sudden voltage change of the first capacitor and the second capacitor when the series/parallel connection manner between the plurality of second-level DC/DC conversion circuits is switched, thereby ensuring safe switching.

With reference to the third aspect, in an implementation, the controller is further configured to: when the voltage of the battery is less than the first voltage threshold or when the voltage of the battery is greater than the second voltage threshold, adjust a PWM signal of the first-level DC/DC conversion circuit to reduce voltage values of the first capacitor and the second capacitor to be less than the third voltage threshold. According to the power conversion circuit provided in the embodiments, control logic for adjusting the voltage values of the first capacitor and the second capacitor is simple, and no circuit component needs to be added, thereby reducing costs and shortening a switching time.

With reference to the third aspect, in an implementation, the controller is configured to control, before the controller adjusts the PWM signal of the first-level DC/DC conversion circuit, each second-level DC/DC conversion circuit to stop operating.

With reference to the third aspect, in an implementation, the controller is further configured to: after adjusting the PWM signal of the first-level DC/DC conversion circuit to reduce the voltage values of the first capacitor and the second capacitor to be less than the third voltage threshold, control the first-level DC/DC conversion circuit to stop operating, so as to ensure that the entire circuit stops operating when the series/parallel connection manner between the plurality of second-level DC/DC conversion circuits is switched, thereby ensuring safe switching.

With reference to the third aspect, in an implementation, the controller is further configured to: after the first-level DC/DC conversion circuit stops operating, control the switching module to be turned off or turned on, so that the plurality of second-level DC/DC conversion circuits are connected in series or in parallel, a time of the entire switching process is short, and the entire loop stops operating during switching, thereby ensuring safe switching.

According to a fourth aspect, the embodiments provide an energy storage system, where the energy storage system includes the energy storage apparatus and the energy storage converter provided in the third aspect, the energy storage apparatus is connected to the energy storage converter, the energy storage converter is configured to convert direct current energy output by the energy storage apparatus into alternating current energy, and output the alternating current energy to a power grid or a load, and/or the energy storage converter is configured to convert the alternating current energy output by the power grid into direct current energy, and output the direct current energy to the energy storage apparatus.

For effects of the energy storage system, refer to detailed descriptions of beneficial effects of the power conversion circuit and a battery pack. Details are not described herein again.

### BRIEF DESCRIPTION OF DRAWINGS

FIG. 1 is a first schematic diagram of a topology of a power conversion circuit according to an embodiment;

FIG. 2 is a second schematic diagram of a topology of a power conversion circuit according to an embodiment;

FIG. 3 is a third schematic diagram of a topology of a power conversion circuit according to an embodiment;

FIG. 4 is a fourth schematic diagram of a topology of a power conversion circuit according to an embodiment;

FIG. 5 is a fifth schematic diagram of a topology of a power conversion circuit according to an embodiment;

FIG. 6 is a sixth schematic diagram of a topology of a power conversion circuit according to an embodiment;

FIG. 7 is a first schematic flowchart of a control method according to an embodiment; and

FIG. 8A and FIG. 8B are a schematic flowchart of a control method according to an embodiment.

### DETAILED DESCRIPTION OF EMBODIMENTS

To make objectives, solutions, and advantages of the embodiments clearer, the following further describes the embodiments in detail with reference to accompanying drawings. However, example implementations can be implemented in a plurality of forms, and should not be construed as being limited to the implementations described herein. Identical reference numerals in the accompanying drawings denote identical or similar structures. Therefore, repeated description thereof is omitted. Expressions of positions and directions in embodiments are described by using the accompanying drawings as an example. However, changes may also be made as required, and all the changes fall within the scope of the embodiments. The accompanying drawings are merely used to illustrate relative positional relationships and do not represent an actual scale.

In embodiments, terms such as “first” and “second” are merely intended for a purpose of description, and shall not be understood as an indication or implication of relative importance or implicit indication of a quantity of indicated features. Therefore, a feature limited by “first” or “second” may explicitly or implicitly include one or more features.

It should be noted that specific details are described below to facilitate understanding of the embodiments. However, the embodiments can be implemented in numerous other manners different from those described herein, and persons skilled in the art can make similar inferences without departing from the connotation of this application. Therefore, the embodiments are not limited to the specific implementations below.

For ease of understanding, terms in embodiments are first explained.

The term “and/or” describes only an association relationship for describing associated objects and represents that three relationships may exist. For example, A and/or B may represent the following three cases: only A exists, both A and B exist, and only B exists.

“A plurality of” means “two or more”.

“Connection” means an electrical connection, and a connection between two electrical components may be a direct or indirect connection between the two electrical components. For example, a connection between A and B may represent that A and B are directly connected to each other, or A and B are indirectly connected to each other through one or more other electrical elements. For example, the connection between A and B may alternatively represent that A and C are directly connected to each other, C and B are directly connected to each other, and A and B are connected to each other through C.

Currently, for large-scale photovoltaic power generation or wind power generation, a voltage of a power grid may be relatively high, for example, an alternating voltage from 400 V to 800 V. Consequently, a direct current-side voltage ranges from 550 V to 1500 V. However, a voltage of a single battery may be relatively low. For example, the voltage of a single battery can be less than 60 V. Therefore, to meet a voltage requirement of the power grid, a plurality of batteries may be directly connected in series to obtain a high voltage. In the power conversion circuit provided in the embodiments, one battery may be one battery pack, and one battery pack may include one battery unit or more battery units (the battery unit may be a single cell, and a voltage of the battery unit can be between 2.5 V and 4.2 V) that are connected in series or in parallel, to form a minimum energy storage and management unit. For ease of description, the following uses a battery as an example for description. In other words, in the power conversion circuit provided in the embodiments, a battery is a minimum energy storage and management unit including one or more battery units that are connected in series or in parallel.

Pulse width modulation ((PWM) is to modulate widths of a series of pulses to obtain a required equivalent waveform (including a shape and an amplitude) and digitally code an analog signal level, that is, to adjust changes of a signal, energy, and the like by adjusting a duty cycle. The duty cycle is a percentage of the time when the signal is at a high level in an entire signal cycle.

A metal-oxide-semiconductor field-effect transistor (MOSFET) is a semiconductor device operating by using a field-effect principle, and may also be referred to as a MOS transistor, and generally includes three terminals: a gate, a source, and a drain.

An insulated gate bipolar transistor (IGBT) is a composite fully controlled voltage-driven power semiconductor device that includes a bipolar junction transistor (BJTt) and a MOSFET, and has advantages of a high input impedance of the MOSFET and a low conduction voltage drop of the BJT.

Relay: an electrical control device. The relay is an electrical control component that enables a step change of a controlled quantity to occur on an electrical output circuit when a change of an input quantity reaches a specified requirement. The relay has an interaction relationship between a control system and a controlled system, and can be used in an automated control circuit. The relay can be understood as an automatic switch that uses a low current to control a high-current operation. Therefore, the relay provides functions such as automatic adjustment, security protection, and circuit conversion in a circuit, and may be widely used in remote control, telemetry, communication, automatic control, electromechanical integration, and power electronic devices, and is one of the most important control components.

Buck-Boost circuit: The Buck-Boost circuit is a common voltage/current conversion circuit, which can implement buck conversion and boost conversion, and may be applied to voltage converters in many power systems.

LLC conversion circuit: The LLC conversion circuit is a resonant circuit that implements outputting of a constant voltage by controlling a switching frequency (frequency regulation), and can implement zero voltage switching (ZVS) of two primary MOS switches on a primary side and zero current switching (ZCS) of a secondary rectifier diode. A soft switching technology can be used to reduce a switching loss of a power supply, and improve efficiency and power density of a power converter.

Dual-active bridge conversion circuit: The dual-active bridge conversion circuit generally includes two full-bridge converters. Alternating current sides of the two full-bridge converters are connected by using an inductor and a transformer. Each full-bridge converter uses square wave modulation to generate a high-frequency square wave on the alternating current side, and ignores excitation reactance. In this case, the dual-active bridge conversion circuit is equivalent to two alternating current sources connected to two ends of the inductor. A magnitude and direction of power flow can be adjusted by adjusting a phase shift between the two alternating current sources. The dual-active bridge conversion circuit can implement the electric isolation and the bidirectional flowing of the power of a direct current transformer, while the high frequency isolation transformer greatly improves the power density and modularity. In an application in the high voltage field, due to limitation of a voltage and a capacity level of a component, dual-active bridge conversion circuits may be connected in series to increase a voltage level or connected in parallel to increase a power level. The dual-active bridge conversion circuit has advantages such as high conversion efficiency, a high power density, low voltage stresses and current stresses of power components, and easy implementation, a simple structure, and easy integration of a soft switch.

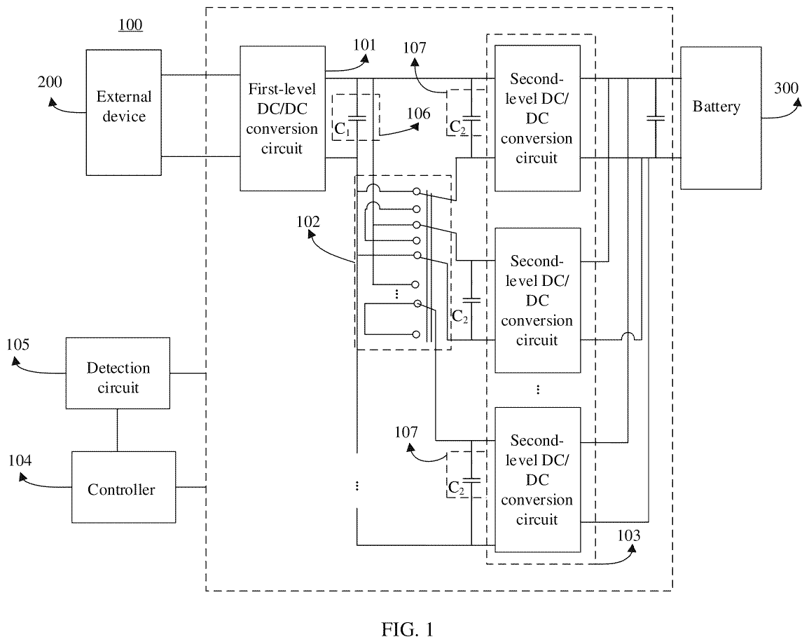

An embodiment provides a power conversion circuit. According to FIG. 1, the power conversion circuit includes a controller 104, a first-level DC/DC conversion circuit 101, a plurality of second-level DC/DC conversion circuits 103, and a switching module 102. A first end of the first-level DC/DC conversion circuit 101 is configured to connect to an external device 200, and a second end of the first-level DC/DC conversion circuit 101 is connected to a first end of the switching module 102. A first end of each second-level DC/DC conversion circuit 103 is connected to a second end of the switching module 102, and a second end of each second-level DC/DC conversion circuit 103 is configured to connect to a battery. A first capacitor 106 is connected in parallel to the first-level DC/DC conversion circuit, and the first capacitor 106 is configured to stabilize a voltage of a second port of the first-level DC/DC conversion circuit. One second capacitor 107 is connected in parallel to each second-level DC/DC conversion circuit, and the second capacitor 107 is configured to stabilize a voltage of a first port of a corresponding second-level DC/DC conversion circuit that is connected. When a voltage of the battery 300 is less than a first voltage threshold, in this case, a boost ratio on both sides of the first-level DC/DC conversion circuit are excessively high, which reduces electric energy conversion efficiency of a system. When voltage values of the first capacitor 106 and the second capacitor 107 are less than a third voltage threshold, the controller 104 controls the switching module 102 to be turned off or turned on, so that the plurality of second-level DC/DC conversion circuits are connected in series. After the switching is completed, a voltage of the second port of the first-level DC/DC conversion circuit 101 is equal to a sum of voltages of first ports of the plurality of second-level DC/DC conversion circuits 103, thereby reducing a boost ratio of the first-level DC/DC conversion circuit 101. When the voltage of the battery 300 is greater than a second voltage threshold, the boost ratio on both sides of the first-level DC/DC conversion circuit are excessively low. When the voltage values of the first capacitor 106 and the second capacitor 107 are less than a third voltage threshold, the controller 104 controls the switching module 102 to be turned off or turned on, so that the plurality of second-level DC/DC conversion circuits 103 are connected in parallel. After the switching is completed, the voltage of the second port of the first-level DC/DC conversion circuit 101 is equal to voltages of the first ports of the plurality of second-level DC/DC conversion circuits 103, so that a boost ratio of the first-level DC/DC conversion circuit 101 is increased.

It should be noted that the controller 104 may be a processor or a controller, such as a general-purpose central processing unit (CPU), a general-purpose processor, a digital signal processor (DSP), an application specific integrated circuit (ASIC), a field programmable gate array (FPGA), or another programmable logic device, a transistor logic device, a hardware component, or any combination thereof. The processor may also be a combination of the foregoing types of controllers for implementing computing functions. For example, the controller 104 may include “one microprocessor or a combination of more than one microprocessor, a combination of a DSP and a microprocessor, or the like.

In some examples, when the voltage of the battery is less than the first voltage threshold, the controller 104 controls the plurality of second-level DC/DC conversion circuits 103 to stop operating. The controller 104 adjusts a PWM signal of the first-level DC/DC conversion circuit 101. After voltages of the first capacitor 106 and the second capacitor 107 are reduced to be less than the third voltage threshold, the controller 104 controls the first-level DC/DC conversion circuit 101 to stop operating. The controller 104 controls the switching module 102 to be turned off or turned on, so that the plurality of second-level DC/DC conversion circuits are connected in series. After the switching is completed, the voltage of the second port of the first-level DC/DC conversion circuit 101 is equal to the sum of the voltages of the first ports of the plurality of second-level DC/DC conversion circuits 103, thereby reducing a boost ratio of the first-level DC/DC conversion circuit 101. When the voltage of the battery 300 is greater than the second voltage threshold, the controller 104 controls the plurality of second-level DC/DC conversion circuits 103 to stop operating. The controller 104 controls and adjusts the PWM signal of the first-level DC/DC conversion circuit 101. After the voltages of the first capacitor 106 and the second capacitor 107 are reduced to be less than the third voltage threshold, the controller controls the first-level DC/DC conversion circuit 101 to stop operating. The controller 104 controls the switching module 102 to be turned off or turned on, so that the plurality of second-level DC/DC conversion circuits are connected in parallel. After the switching is completed, the voltage of the second port of the first-level DC/DC conversion circuit 101 is equal to voltages of the first ports of the plurality of second-level DC/DC conversion circuits 103, so that the boost ratio of the first-level DC/DC conversion circuit 101 is increased, and the battery is within a normal operating voltage range. This improves electric energy conversion efficiency within a wide operating voltage range, and avoids damage to a switch or a component connected to the switch due to a sudden voltage change of the first capacitor 106 and the second capacitor 107 when the series/parallel connection manner between the plurality of second-level DC/DC conversion circuits 103 is switched, thereby ensuring safe switching. According to the power conversion circuit provided in this embodiment, control logic for adjusting voltage values of the first capacitor 106 and the second capacitor 107 is simple, and no circuit component needs to be added, thereby reducing costs and shortening a switching time.

In some examples, the first-level DC/DC conversion circuit 101 is configured to reduce a voltage of a first port of the first-level DC/DC conversion circuit 101, and the second-level DC/DC conversion circuit 103 is configured to reduce a voltage of a first port of the second-level DC/DC conversion circuit 103 to a charging voltage required by the battery, so as to charge the battery. When the battery is in a discharging state, the second-level DC/DC conversion circuit 103 is configured to boost a voltage of the second port of the second-level DC/DC conversion circuit 103, and the first-level DC/DC conversion circuit 101 is configured to boost a voltage of a second port of the first-level DC/DC conversion circuit 101 and output the boosted voltage to the external device 200. The power conversion circuit may be applied to both a battery charging scenario and a battery discharging scenario, to implement bidirectional conversion of electric energy. The power conversion circuit may be used in a wide range of scenarios, thereby improving application flexibility of the power conversion circuit.

In some examples, the power conversion circuit further includes a detection circuit 105. The detection circuit 105 is configured to detect a voltage value of the battery and a voltage value of the first capacitor 106 and a voltage value of the second capacitor 107, to accurately detect a charging/discharging voltage of the battery 300, and accordingly change a series/parallel connection manner between the plurality of second-level DC/DC conversion circuits 103, so as to change the voltage of the second port of the first-level DC/DC conversion circuit 101, change a boost ratio on both sides of the first-level DC/DC conversion circuit 101, and improve the electric energy conversion efficiency of the system. The power conversion circuit accurately detects the voltages of the first capacitor 106 and the second capacitor 107, to ensure that the voltages of the first capacitor 106 and the second capacitor 107 are less than the third voltage threshold during series/parallel switching and are reduced to be less than a safe operating voltage, thereby preventing a component from being damaged due to a high current generated by a sudden voltage change, and ensuring safe switching. A specific location of the detection circuit 105 is not limited in this embodiment. For example, the detection circuit 105 may be a part of the controller 104, or may be independent of the controller 104. The controller 104 is configured to obtain the voltage values that are of the battery, the first capacitor 106, and the second capacitor 107 and that are detected by the detection circuit 105.

A communication manner between the controller 104 and the detection circuit 105, the first-level DC/DC conversion circuit 101, and the second-level DC/DC conversion circuit 103 is not limited in this embodiment. The communication manner may be a wired communication manner or a wireless communication manner. The controller 104 and the detection circuit 105 may communicate based on an RS-485 bus, or communicate based on a CAN (controller area network) protocol. In another embodiment, communication may also be performed based on another communication manner.

In some examples, the switching module 102 includes a relay, a MOS transistor, or an IGBT. Specific quantities of relays, MOS transistors, and IGBT in the switching module 102 are not limited in this embodiment. Specific quantities and connection manners are determined by a person skilled in the art based on a specific application scenario, a system architecture, and a specific quantity of the second-level DC/DC conversion circuits 103.

In some examples, the first-level DC/DC conversion circuit 101 is a Buck-Boost circuit, and the second-level DC/DC conversion circuit 103 is an LLC conversion circuit. Both the Buck-Boost circuit and the LLC conversion circuit can implement bidirectional power conversion. The LLC conversion circuit has a simple structure, and generally includes components such as a switching transistor, a transformer, a capacitor, and an inductor. The LLC conversion circuit has a small size and has a high power density, thereby improving electric energy conversion efficiency. The LLC conversion circuit may output a plurality of different direct current voltages, to meet battery charging requirements in different scenarios, and improve flexibility of the power conversion circuit. In addition, a plurality of LLC conversion circuits may be electrically isolated. When the battery is in a charging state, the Buck-Boost circuit is configured to reduce a voltage of a first port of the Buck-Boost circuit, and the LLC conversion circuit is configured to reduce a voltage of a first port of the LLC conversion circuit to a charging voltage required by the battery. When the battery is in a discharging state, the LLC conversion circuit is configured to boost a voltage of a second port of the LLC conversion circuit, and the Buck-Boost circuit is configured to boost a voltage of a second port of the Buck-Boost circuit and then output the boosted voltage to an external device.

In some examples, the first-level DC/DC conversion circuit 101 is a Buck-Boost circuit, and the second-level DC/DC conversion circuit is a dual-active bridge conversion circuit. When the battery is in the charging state, the Buck-Boost circuit is configured to reduce the voltage of the first port of the Buck-Boost circuit, and the dual-active bridge conversion circuit is configured to reduce the voltage of the first port of the dual-active bridge conversion circuit to a charging voltage required by the battery. When the battery is in the discharging state, the dual-active bridge conversion circuit is configured to boost the voltage of the second port of the dual-active bridge, and the Buck-Boost circuit is configured to boost the voltage of the second port of the Buck-Boost circuit and output the boosted voltage to an external device.

It should be noted that specific topology structures of the first-level DC/DC conversion circuit 101 and the second-level DC/DC conversion circuit 103 are not limited in this embodiment. For example, when the power conversion circuit provided in this embodiment is used only in a charging scenario or used only in a discharging scenario, the first-level DC/DC conversion circuit 101 may alternatively be a buck circuit or a boost circuit, and the second-level DC/DC conversion circuit 103 may alternatively be a bridge topology of another type.

A quantity of second-level DC/DC conversion circuits 103 is not limited in this embodiment. For example, the power conversion circuit may include two second-level DC/DC conversion circuits, three second-level DC/DC conversion circuits, four second-level DC/DC conversion circuits, and the like. A quantity of switches matches the quantity of the second-level DC/DC conversion circuits. A person skilled in the art may choose to set the quantities of the second-level DC/DC conversion circuits and the switches based on a specific application scenario and a specific requirement.

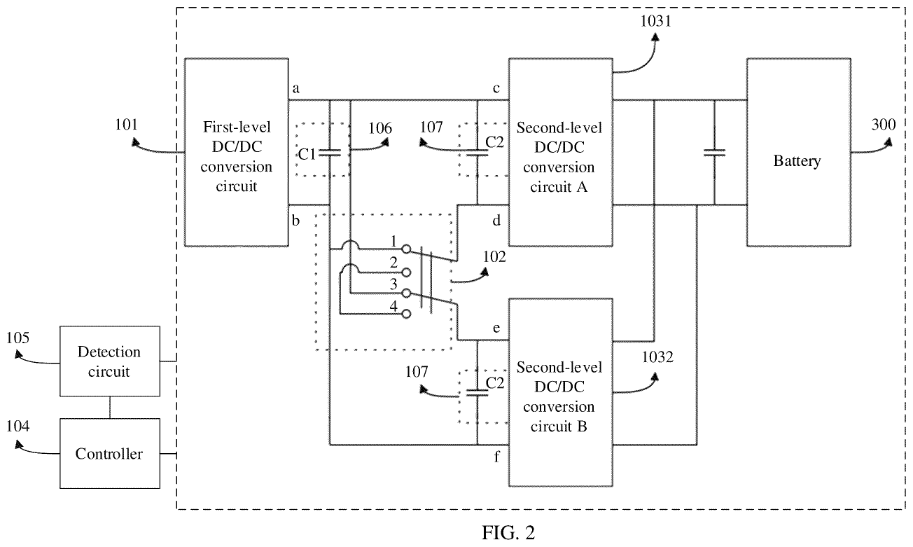

Optionally, the power conversion circuit includes two second-level DC/DC conversion circuits 103, that is, the power conversion circuit includes a second-level DC/DC conversion circuit A1031 and a second-level DC/DC conversion circuit B1032. As shown in FIG. 2, a first end of a first-level DC/DC conversion circuit 101 is connected to an external device, a second end of the first-level DC/DC conversion circuit 101 is connected to a first end of a switching module 102, a first connection point a of the first-level DC/DC conversion circuit 101 is connected to a first connection point c of a second-level DC/DC conversion circuit A1031, a second connection point b of the first-level DC/DC conversion circuit 101 is connected to a second connection point f of a second-level DC/DC conversion circuit B1032, a second connection point d of the second-level DC/DC conversion circuit A1031 is connected to the first end of the switching module 102, and a first connection point e of the second-level DC/DC conversion circuit B1032 is connected to the second end of the switching module 102. A second end of the second-level DC/DC conversion circuit A1031 and a second end of the second-level DC/DC conversion circuit B1032 are connected to a first end of a battery.

Optionally, according to FIG. 2, the power conversion circuit includes a first-level DC/DC conversion circuit 101, a second-level DC/DC conversion circuit A1031, and a second-level DC/DC conversion circuit B1032. The switching module 102 includes a relay, and the relay includes four contacts: a first contact 1, a second contact 2, a third contact 3, and a fourth contact 4. When the second connection point d of the second-level DC/DC conversion circuit A1031 is connected to the second contact 2, and the first connection point e of the second-level DC/DC conversion circuit B1032 is connected to the fourth contact 4, the second-level DC/DC conversion circuit A1031 is connected to the second-level DC/DC conversion circuit B1032 in series. When the second connection point d of the second-level DC/DC conversion circuit A1031 is connected to the first contact 1, and the first connection point e of the second-level DC/DC conversion circuit B1032 is connected to the third contact 3, the second-level DC/DC conversion circuit A1031 is connected to the second-level DC/DC conversion circuit B1032 in parallel.

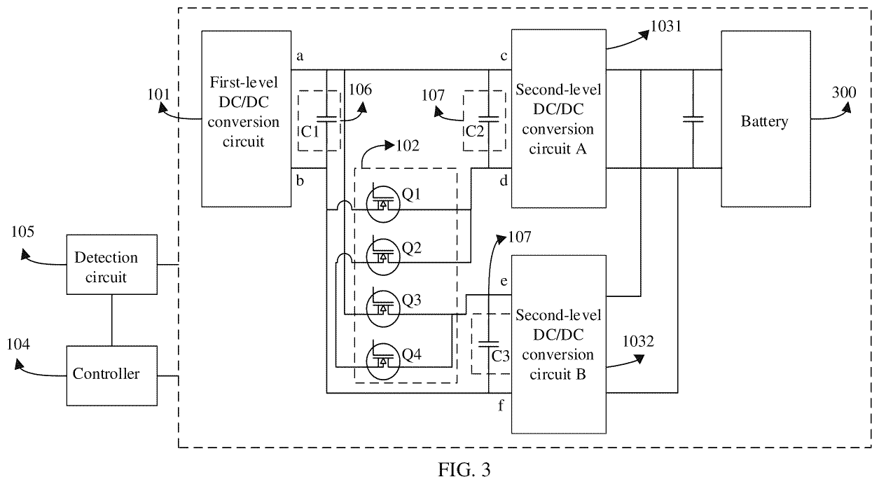

Optionally, the power conversion circuit includes the first-level DC/DC conversion circuit 101, the second-level DC/DC conversion circuit A1031, and the second-level DC/DC conversion circuit B1032. The switching module 102 includes four MOS transistors: a first MOS transistor Q1, a second MOS transistor Q2, a third MOS transistor Q3, and a fourth MOS transistor Q4, as shown in FIG. 3. A first end of the first MOS transistor Q1 is connected to a second connection point b of the first-level DC/DC conversion circuit 101, a second end of the first MOS transistor Q1 is connected to a second connection point d of the second-level DC/DC conversion circuit A1031, a first end of the second MOS transistor Q2 is connected to a first end of the fourth MOS transistor Q4, a second end of the second MOS transistor Q2 is connected to the second connection point d of the second-level DC/DC conversion circuit A1031, a first end of the third MOS transistor Q3 is connected to the first connection point b of the first-level DC/DC conversion circuit 101B, a second end of the third MOS transistor Q3 is connected to a first connection point e of the second-level DC/DC conversion circuit B1032, the first end of the fourth MOS transistor Q4 is connected to the first end of the second MOS transistor Q2, and a second end of the fourth MOS transistor Q4 is connected to the first connection point e of the second-level DC/DC conversion circuit B1032. When the first MOS transistor Q1 and the third MOS transistor Q3 are turned on, and the second MOS transistor Q2 and the fourth MOS transistor Q4 are turned off, the second-level DC/DC conversion circuit A is connected in parallel to the second-level DC/DC conversion circuit B. When the second MOS transistor Q2 and the fourth MOS transistor Q4 are turned on, and the first MOS transistor Q1 and the third MOS transistor Q3 are turned off, the second-level DC/DC conversion circuit A is connected in series to the second-level DC/DC conversion circuit B.

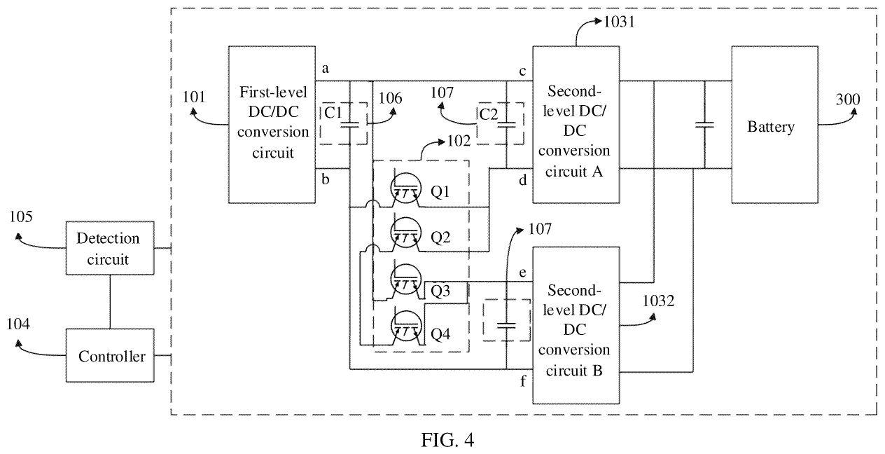

Optionally, the power conversion circuit includes the first-level DC/DC conversion circuit 101, the second-level DC/DC conversion circuit A1031, and the second-level DC/DC conversion circuit B1032. The switching module 102 includes four IGBTs: a first IGBT Q1, a second IGBT Q2, a third IGBT Q3, and a fourth IGBT Q4, as shown in FIG. 4. The power conversion circuit provided in this embodiment includes the first IGBT Q1, the second IGBT Q2, the third IGBT Q3, and the fourth IGBT Q4. A first end of the first IGBT Q1 is connected to a second connection point b of the first-level DC/DC conversion circuit 101, a second end of the first IGBT Q1 is connected to a second connection point d of a second-level DC/DC conversion circuit A1031, a first end of the second IGBT Q2 is connected to a first end of the fourth IGBT Q4, a second end of the second IGBT Q2 is connected to the second connection point d of the second-level DC/DC conversion circuit A1031, a first end of the third IGBT Q3 is connected to the first connection point b of the first-level DC/DC conversion circuit 101B, a second end of the third IGBT Q3 is connected to a first connection point e of the second-level DC/DC conversion circuit B1032, the first end of the fourth IGBT Q4 is connected to the first end of the second IGBT Q2, and a second end of the fourth IGBT Q4 is connected to the first connection point e of the second-level DC/DC conversion circuit B1032. When the first IGBT Q1 and the third IGBT Q3 are turned on, and the second IGBT Q2 and the fourth IGBT Q4 are turned off, the second-level DC/DC conversion circuit A is connected in parallel to the second-level DC/DC conversion circuit B. When the second IGBT Q2 and the fourth IGBT Q4 are turned on, and the first IGBT Q1 and the third IGBT Q3 are turned off, the second-level DC/DC conversion circuit A1031 is connected in series to the second-level DC/DC conversion circuit B1032.

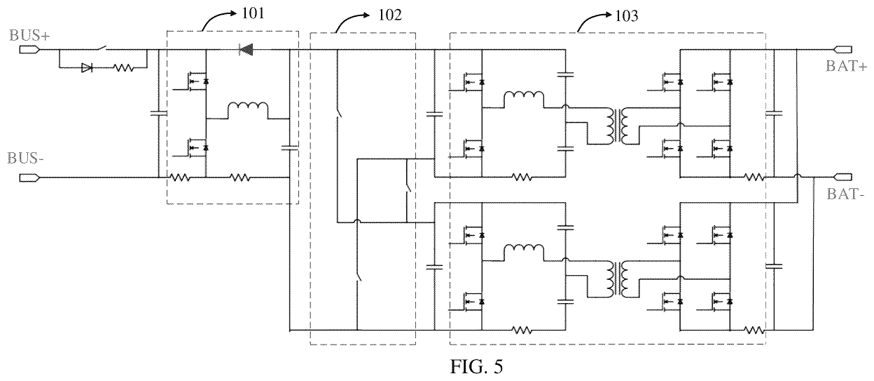

Optionally, the power conversion circuit includes a first-level DC/DC conversion circuit 101 and two second-level DC/DC conversion circuits 103. According to FIG. 5, the two second-level DC/DC conversion circuits are two LLC conversion circuits. When a voltage of a battery is less than a first voltage threshold, a controller 104 controls each LLC conversion circuit to stop operating. The controller 104 adjusts a PWM signal of the first-level DC/DC conversion circuit 101 to reduce voltages at two ends of the first capacitor 106 and the second capacitor 107 to be less than a third voltage threshold, the controller 104 controls the first-level DC/DC conversion circuit 101 to stop operating. The controller 104 controls the switching module 102 to turn off K1 and K3 and turn on K2. After the switching is completed, the two LLC conversion circuits are in a series connection mode, and a voltage of the second port of the first-level DC/DC conversion circuit 101 is a sum of voltages of the first ports of the two LLC conversion circuits, so as to reduce a boost ratio on both sides of the first-level DC/DC conversion circuit 101. When the voltage of the battery is greater than a second voltage threshold, and in this case, the voltage of the second port of the first-level DC/DC conversion circuit 101 is excessively high, the controller 104 controls each LLC conversion circuit to stop operating, the controller 104 adjusts the PWM signal of the first-level DC/DC conversion circuit 101, to reduce voltages at two ends of the first capacitor 106 and the second capacitor 107 to be less than the third voltage threshold. The controller 104 controls the first-level DC/DC conversion circuit 101 to stop operating. The controller 104 controls the switching module 102 to turn on K1 and K3 and turn off K2. After the switching is completed, the two LLC conversion circuits are in a parallel connection mode, and a voltage of a second port of the first-level DC/DC conversion circuit 101 is equal to voltages of the first ports of the two LLC conversion circuits, thereby meeting a requirement of a battery operating voltage.

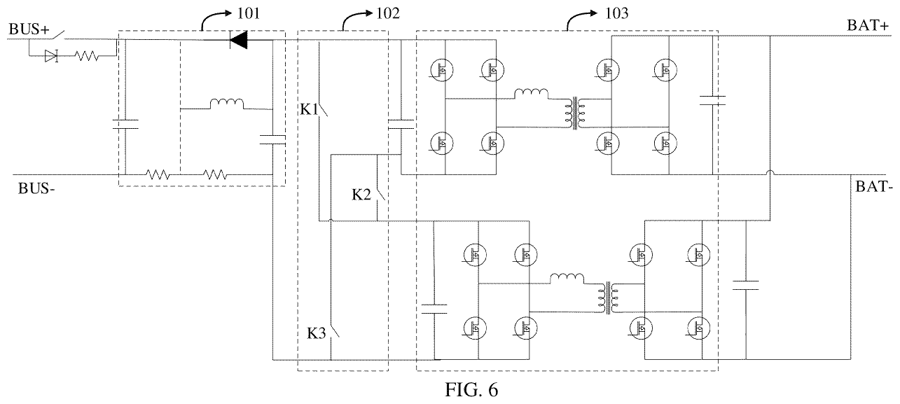

According to FIG. 6, the power conversion circuit includes a first-level DC/DC conversion circuit 101 and two second-level DC/DC conversion circuits. The two second-level DC/DC conversion circuits are two dual-active bridge conversion circuits. When a voltage of a battery is less than a first voltage threshold, a controller 104 controls each dual-active bridge conversion circuit to stop operating, the controller 104 adjusts a PWM signal of the first-level DC/DC circuit to reduce voltages at two ends of the first capacitor 106 and the second capacitor 107 to be less than a third voltage threshold, the controller 104 controls the first-level DC/DC conversion circuit 101 to stop operating. The controller 104 controls the switching module 102 to turn off K1 and K3 and turn on K2. After the switching is completed, the two dual-active bridge conversion circuits are in a series connection mode, and a voltage of the second port of the first-level DC/DC conversion circuit 101 is a sum of the voltage of the first ports of the two dual-active bridge conversion circuits, so as to reduce a boost ratio on both sides of the first-level DC/DC conversion circuit 101. When the voltage of the battery is greater than a second voltage threshold, and in this case, the voltage of the second port of the first-level DC/DC conversion circuit 101 is excessively high, the controller 104 controls each dual-active bridge conversion circuit to stop operating, the controller 104 adjusts the PWM signal of the first-level DC/DC conversion circuit 101, to reduce the voltages at two ends of the first capacitor 106 and the second capacitor 107 to be less than a third voltage threshold. The controller 104 controls the first-level DC/DC conversion circuit 101 to stop operating. The controller 104 controls the switching module 102 to turn on K1 and K3 and turn off K2. After the switching is completed, the two dual-active bridge conversion circuits are in a parallel connection mode, and the voltage of the second port of the first-level DC/DC conversion circuit 101 is equal to voltages of the first ports of the two dual-active bridge conversion circuits, thereby meeting a requirement of a battery operating voltage.

It should be noted that none of the first voltage threshold, the second voltage threshold, and the third voltage threshold is limited in this embodiment. A person skilled in the art may preset related parameters based on a specific application scenario and a system architecture.

For example, if an operating voltage range of the battery is 20 V to 30 V, the first voltage threshold is set to 24 V, the second voltage threshold is set to 26 V, and the third voltage threshold is set to 20 V. A voltage range of a first port of the first-level DC/DC conversion circuit 101 is 600 V to 900 V. When the system is in a charging state, the detection circuit 105 detects a voltage value of the battery in real time. When the battery voltage is less than 24 V, the controller 104 controls the plurality of second-level DC/DC conversion circuits 103 to stop operating. The controller 104 controls a PWM signal of the first-level DC/DC conversion circuit 101. After the voltages at two ends of the first capacitor 106 and the second capacitor 107 are reduced to be less than 20 V, the controller 104 controls the first-level DC/DC conversion circuit 101 to stop operating. After the entire circuit stops operating, the controller 104 controls the switching module 102 to be turned off or turned on, so that the plurality of second-level DC/DC conversion circuits 103 are in a series connection mode. The controller 104 confirms that the switching is completed, and the controller 104 indicates the first-level DC/DC conversion circuit 101 and the plurality of second-level DC/DC conversion circuits 103 to resume operating. If the switching fails, the system generates an alarm and shuts down. When the battery voltage is greater than 26 V, the controller 104 controls each second-level DC/DC conversion circuit 103 to stop operating. The controller 104 controls a PWM signal of the first-level DC/DC conversion circuit 101. After the voltages at two ends of the first capacitor 106 and the second capacitor 107 are reduced to be less than 20 V, the controller 104 controls the first-level DC/DC conversion circuit 101 to stop operating. After the entire circuit stops operating, the controller 104 controls the switching module 102 to be turned off or turned on, so that the plurality of second-level DC/DC conversion circuits 103 are in a parallel connection mode. The controller 104 confirms that the switching is completed, and the controller 104 indicates the first-level DC/DC conversion circuit 101 and the plurality of second-level DC/DC conversion circuits 103 to resume operating. If the switching fails, the system generates an alarm and shuts down.

In some examples, the external device 200 is a direct current source. The first-level DC/DC conversion circuit 101 receives an output voltage of the direct current source, performs voltage conversion, and provides an output voltage to a plurality of second-level DC/DC conversion circuits 103. After performing voltage conversion on the output voltage provided by the first-level DC/DC conversion circuit 101, the second-level DC/DC conversion circuit 103 provides an input voltage required for charging the battery.

In some examples, the external device 200 is a load. The battery provides an output voltage to each second-level DC/DC conversion circuit 103. The second-level DC/DC conversion circuit 103 performs voltage conversion on the output voltage provided by the battery, and then transmits the converted voltage to the first-level DC/DC conversion circuit 101. The first-level DC/DC conversion circuit 101 converts the input voltage provided by the second-level DC/DC conversion circuit 103 into a voltage required by the external load, and supplies power to the external load.

In some examples, the external device 200 is an energy storage converter. When the battery 300 is in a charging state, the first-level DC/DC conversion circuit 101 receives an output voltage of the energy storage converter, performs voltage conversion, and provides an output voltage to a plurality of second-level DC/DC conversion circuits 103. After performing voltage conversion on the output voltage provided by the first-level DC/DC conversion circuit 101, the second-level DC/DC conversion circuit 103 provides an input voltage required for charging the battery. When the battery 300 is in a discharging state, the battery provides an output voltage to each second-level DC/DC conversion circuit 103. The second-level DC/DC conversion circuit 103 performs voltage conversion on the output voltage provided by the battery, and then transmits the converted voltage to the first-level DC/DC conversion circuit 101. The first-level DC/DC conversion circuit 101 converts the input voltage provided by the second-level DC/DC conversion circuit 103, and then provides an output voltage to the energy storage converter.

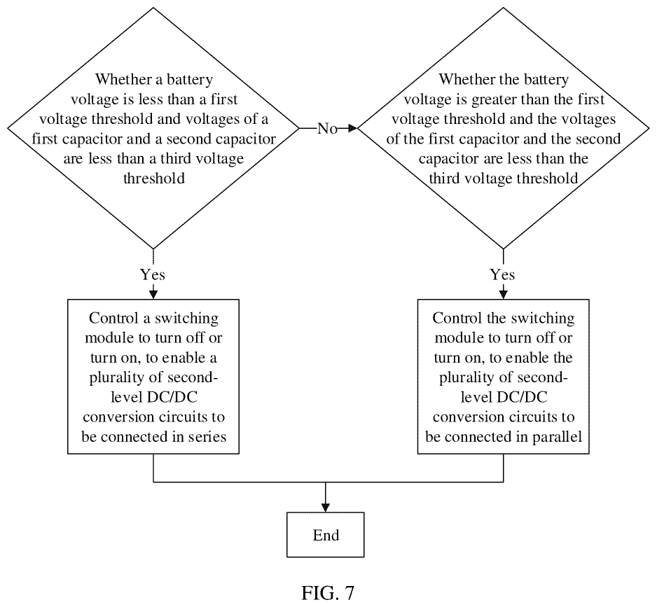

An embodiment further provides a control method for a power conversion circuit. As shown in FIG. 7, in some examples, the power conversion circuit includes a controller 104, a first-level DC/DC conversion circuit 101, a plurality of second-level DC/DC conversion circuits 103, and a switching module 102. A first end of the first-level DC/DC conversion circuit 101 is configured to connect to an external device 200, and a second end of the first-level DC/DC conversion circuit 101 is connected to a first end of the switching module 102. A first end of each second-level DC/DC conversion circuit 103 is connected to a second end of the switching module 102, and a second end of each second-level DC/DC conversion circuit 103 is configured to connect to a battery. The control method includes: when a voltage of the battery 300 is less than a first voltage threshold, in this case, a boost ratio on both sides of the first-level DC/DC conversion circuit are excessively high, which reduces electric energy conversion efficiency of a system; when voltage values of the first capacitor 106 and the second capacitor 107 are less than a third voltage threshold, controlling the switching module 102 to be turned off or turned on, so that the plurality of second-level DC/DC conversion circuits are connected in series; after the switching is completed, a voltage of the second port of the first-level DC/DC conversion circuit 101 is equal to a sum of voltages of first ports of the plurality of second-level DC/DC conversion circuits 103, thereby reducing a boost ratio of the first-level DC/DC conversion circuit 101, and improving electric energy conversion efficiency of the system; when the voltage of the battery 300 is greater than a second voltage threshold, the boost ratio on both sides of the first-level DC/DC conversion circuit are excessively low; and when the voltage values of the first capacitor 106 and the second capacitor 107 are less than a third voltage threshold, controlling the switching module 102 to be turned off or turned on, so that the plurality of second-level DC/DC conversion circuits 103 are connected in parallel. After the switching is completed, the voltage of the second port of the first-level DC/DC conversion circuit 101 is equal to voltages of the first ports of the plurality of second-level DC/DC conversion circuits 103, so that a boost ratio of the first-level DC/DC conversion circuit 101 is increased, and the battery operates within a normal operating voltage range. According to the control method, when the plurality of second-level DC/DC conversion circuits 103 perform series/parallel connection switching, the voltages of the first capacitor 106 and the second capacitor 107 are reduced to be less than a safe operating voltage value, so as to avoid a sudden voltage change of the capacitor, so that a high current is not caused by a sudden voltage change of each capacitor, and a switch or a component connected to each capacitor is not damaged. Control logic is simple, and a switching time is short, thereby improving electric energy conversion efficiency of the system.

It should be noted that none of the first voltage threshold, the second voltage threshold, and the third voltage threshold is limited in this embodiment. A person skilled in the art may preset related parameters based on a specific application scenario and a system architecture.

In some examples, the control method for a power conversion circuit includes: when the voltage of the battery is less than the first voltage threshold or when the voltage of the battery is greater than the second voltage threshold, adjusting the PWM signal of the first-level DC/DC conversion circuit 101 to reduce the voltage values of the first capacitor 106 and the second capacitor 107 to be less than the third voltage threshold, so as to ensure that the voltages at two ends of the first capacitor 106 and the second capacitor 107 are within a safe operating voltage range before the plurality of second-level DC/DC conversion circuits 103 are switched, and avoid a sudden voltage change of the first capacitor 106 and the second capacitor 107.

In some examples, the control method for a power conversion circuit includes: before the PWM signal of the first-level DC/DC conversion circuit 101 is adjusted, controlling each second-level DC/DC conversion circuit 103 to stop operating.

In some examples, the control method for a power conversion circuit includes: after the PWM signal of the first-level DC/DC conversion circuit 101 is adjusted to reduce the voltages of the first capacitor 106 and the second capacitor 107 to be less than the third voltage threshold, controlling the first-level DC/DC conversion circuit 101 to stop operating, so as to ensure that when the series/parallel connection manner between the plurality of second-level DC/DC conversion circuits 103 is switched, the entire circuit stops operating, thereby ensuring safe switching.

In some examples, the control method for a power conversion circuit includes: after the first-level DC/DC conversion circuit 101 is controlled to stop operating, controlling the switching module 102 to be turned off or turned on, so that the plurality of second-level DC/DC conversion circuits 103 are connected in series or in parallel.

In some examples, the control method for a power conversion circuit includes: detecting a voltage value of the battery 300 and voltage values of the first capacitor 106 and the second capacitor 107. In this method, a charging/discharging voltage of the battery 300 is accurately detected, and a series/parallel connection manner between the plurality of second-level DC/DC conversion circuits 103 is changed accordingly, so as to change a voltage of a second port of the first-level DC/DC conversion circuit 101, change a boost ratio on both sides of the first-level DC/DC conversion circuit 101, and improve electric energy conversion efficiency of a system. In the method, the voltages of the first capacitor 106 and the second capacitor 107 are further accurately detected, to ensure that the voltages of the first capacitor 106 and the second capacitor 107 are already less than the third voltage threshold during series/parallel switching, and are reduced to be less than a safe operating voltage, thereby preventing a component from being damaged due to a high current generated by a sudden voltage change, and ensuring safe switching.

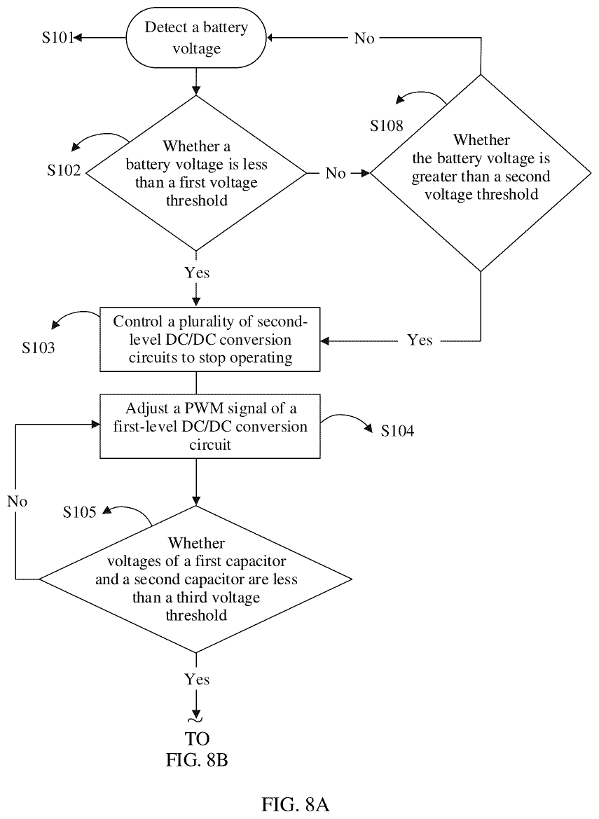

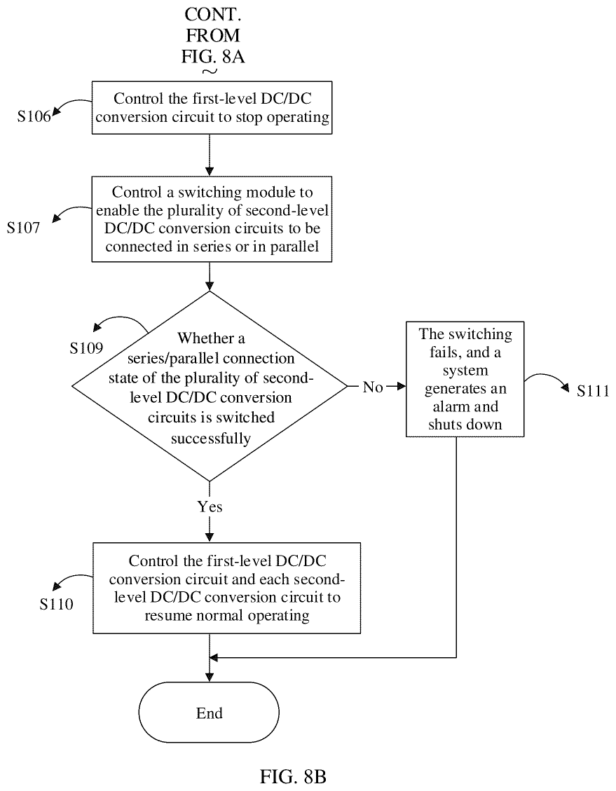

The following uses method steps as an example to describe operating logic of the control method. As shown in FIG. 8A and FIG. 8B, the control method includes the following steps.

Step S101: Detect a battery voltage.

Step S102: Determine whether the battery voltage is less than a first voltage threshold; and if the battery voltage is less than the first voltage threshold, perform step S103; or if the battery voltage is not less than the first voltage threshold, perform step S108.

Step S103: Control a plurality of second-level DC/DC conversion circuits to stop operating.

Step S104: Adjust a PWM signal of a first-level DC/DC conversion circuit.

Step S105: Determine whether voltages of a first capacitor and a second capacitor are less than a third voltage threshold; and if the voltages of the first capacitor and the second capacitor are less than the third voltage threshold, perform step S106; or if the voltages of the first capacitor and the second capacitor are not less than the third voltage threshold, perform step S104.

Step S106: Control the first-level DC/DC conversion circuit to stop operating.

Step S107: Control a switching module to enable a plurality of second-level DC/DC conversion circuits to be connected in series or in parallel.

Step S108: Determine whether the battery voltage is greater than a second voltage threshold; and if the battery voltage is greater than the second voltage threshold, perform step S103.

Step S109: Determine whether a series/parallel connection state of the plurality of second-level DC/DC conversion circuits is switched successfully; and if the switching succeeds, perform step S110; or if the switching fails, perform step S111.

Step S110: Control the first-level DC/DC conversion circuit and each second-level DC/DC conversion circuit to resume normal operating.

Step S111: A system generates an alarm and shuts down.

An embodiment provides an energy storage apparatus. According to FIG. 1, the energy storage apparatus includes a battery 300, a controller 104, a first-level DC/DC conversion circuit, a plurality of second-level DC/DC conversion circuits, and a switching module 102. A first end of the first-level DC/DC conversion circuit is configured to connect to an external device 200, and a second end of the first-level DC/DC conversion circuit is connected to a first end of the switching module 102. A first end of each second-level DC/DC conversion circuit 103 is connected to a second end of the switching module 102, and a second end of each second-level DC/DC conversion circuit 103 is connected to the battery 300. One first capacitor 106 is connected in parallel to the first-level DC/DC conversion circuit; and one second capacitor 107 is connected in parallel to each second-level DC/DC conversion circuit. The controller 104 is configured to: when a voltage of the battery 300 is less than a first voltage threshold and voltage values of the first capacitor 106 and the second capacitor 107 are less than a third voltage threshold, control the switching module 102 to be turned off or turned on, so that the plurality of second-level DC/DC conversion circuits are connected in series; or when the voltage of the battery 300 is greater than a second voltage threshold and the voltage values of the first capacitor 106 and the second capacitor 107 are less than the third voltage threshold, control the switching module 102 to be turned off or turned on, so that the plurality of second-level DC/DC conversion circuits are connected in parallel. The energy storage apparatus includes two-level DC/DC conversion circuits. Two-level voltage conversion is performed on a voltage output by a power grid, and then the voltage is output to the battery 300, so that a voltage boost of the two-level DC/DC conversion circuits is relatively low, and operating efficiency of the energy storage apparatus is improved. The energy storage apparatus provided in this embodiment can not only implement bidirectional flowing of electric energy, but also adjust a PWM signal of the first-level DC/DC conversion circuit 101 before the boost ratio on both sides of the first-level DC/DC conversion circuit 101 need to be changed by switching the series/parallel connection manner between the plurality of second-level DC/DC conversion circuits 103, so that a voltage of the first capacitor 106 and a voltage of the second capacitor 107 are reduced to be less than a third voltage threshold, to ensure that the voltage of the capacitor is less than a safe operating voltage before the series/parallel connection switching. This avoids a case in which a sudden voltage change occurs on the first capacitor 106 and the second capacitor 107 after the series/parallel connection switching is completed, thereby improving electric energy conversion efficiency, and ensuring safe switching, without damaging a load and a component that are connected to the capacitor.

In some examples, the controller 104 is configured to: when the voltage of the battery 300 is less than a first voltage threshold or when the voltage of the battery 300 is greater than a second voltage threshold, adjust a PWM signal of the first-level DC/DC conversion circuit 101 to reduce voltage values of the first capacitor 106 and the second capacitor 107 to be less than a third voltage threshold. According to the power conversion circuit provided in the embodiments, control logic for adjusting voltage values of the first capacitor 106 and the second capacitor 107 is simple, and no circuit component needs to be added, thereby reducing costs and shortening a switching time.

In some examples, the controller 104 is configured to: before the controller 104 adjusts the PWM signal of the first-level DC/DC conversion circuit 101, control each second-level DC/DC conversion circuit 103 to stop operating.

In some examples, the controller 104 is further configured to: after adjusting the PWM signal of the first-level DC/DC conversion circuit 101 to reduce the voltage values of the first capacitor 106 and the second capacitor 107 to be less than the third voltage threshold, control the first-level DC/DC conversion circuit 101 to stop operating, so as to ensure that the entire circuit stops operating when the series/parallel connection manner between the plurality of second-level DC/DC conversion circuits 103 is switched, thereby ensuring safe switching.

In some examples, the controller 104 is further configured to: after the first-level DC/DC conversion circuit 101 stops operating, control the switching module 102 to be turned off or turned on, so that the plurality of second-level DC/DC conversion circuits 103 are connected in series or in parallel, a time of the entire switching process is short, and the entire loop stops operating during switching, thereby ensuring safe switching.

An embodiment provides an energy storage system. The energy storage system includes the energy storage apparatus and the energy storage converter provided in the third aspect, the energy storage apparatus is connected to the energy storage converter, the energy storage converter is configured to convert direct current energy output by the energy storage apparatus into alternating current energy, and output the alternating current energy to a power grid or a load, and/or the energy storage converter is configured to convert the alternating current energy output by the power grid into direct current energy, and output the direct current energy to the energy storage apparatus. The energy storage system provided in this embodiment can not only implement bidirectional flowing of electric energy, but also adjust a PWM signal of the first-level DC/DC conversion circuit before the boost ratio on both sides of the first-side DC/DC conversion circuit need to be changed by switching the series/parallel connection manner between the plurality of second-level DC/DC conversion circuits, so that the voltages of the first capacitor and the second capacitor are reduced to be less than the third voltage threshold. This avoids a case in which a sudden voltage change occurs on the first capacitor and the second capacitor after the series/parallel connection switching is completed, thereby improving the electric energy conversion efficiency of the system, and ensuring safe switching.

The foregoing descriptions are merely implementations of embodiments, but are not intended as limiting. Any variation or replacement readily figured out by a person skilled in the art shall fall within the scope of the embodiments.

1. A power conversion circuit, comprising:
a controller,
a first-level DC/DC conversion circuit,
a plurality of second-level DC/DC conversion circuits, and
a switching module;
a first end of the first-level DC/DC conversion circuit is configured to connect to an external device, and a second end of the first-level DC/DC conversion circuit is connected to a first end of the switching module; and a first end of each second-level DC/DC conversion circuit is connected to a second end of the switching module, and a second end of each second-level DC/DC conversion circuit is configured to connect to a battery;
one first capacitor is connected in parallel to the first-level DC/DC conversion circuit;
one second capacitor is connected in parallel to each second-level DC/DC conversion circuit; and
the controller is configured to:
when a voltage of the battery is less than a first voltage threshold and voltage values of the first capacitor and the second capacitor are less than a third voltage threshold, control the switching module to be turned off or turned on, so that the plurality of second-level DC/DC conversion circuits are connected in series; or
when the voltage of the battery is greater than a second voltage threshold and the voltage values of the first capacitor and the second capacitor are less than the third voltage threshold, control the switching module to be turned off or turned on, so that the plurality of second-level DC/DC conversion circuits are connected in parallel.

2. The power conversion circuit according to claim 1, wherein the controller is further configured to: when the voltage of the battery is less than the first voltage threshold or when the voltage of the battery is greater than the second voltage threshold, adjust a pulse width modulation (PWM) signal of the first-level DC/DC conversion circuit to reduce voltage values of the first capacitor and the second capacitor to be less than the third voltage threshold.

3. The power conversion circuit according to claim 2, wherein the controller is further configured to: before adjusting the PWM signal of the first-level DC/DC conversion circuit, control each second-level DC/DC conversion circuit to stop operating.

4. The power conversion circuit according to claim 2, wherein the controller is further configured to: after adjusting the PWM signal of the first-level DC/DC conversion circuit to reduce the voltage values of the first capacitor and the second capacitor to be less than the third voltage threshold, control the first-level DC/DC conversion circuit to stop operating.

5. The power conversion circuit according to claim 3, wherein the controller is further configured to: after adjusting the PWM signal of the first-level DC/DC conversion circuit to reduce the voltage values of the first capacitor and the second capacitor to be less than the third voltage threshold, control the first-level DC/DC conversion circuit to stop operating.

6. The power conversion circuit according to claim 4, wherein the controller is further configured to: after the first-level DC/DC conversion circuit stops operating, control the switching module to be turned off or turned on, so that the plurality of second-level DC/DC conversion circuits are connected in series or in parallel.

7. The power conversion circuit according to claim 5, wherein the controller is configured to: after the first-level DC/DC conversion circuit stops operating, control the switching module to be turned off or turned on, so that the plurality of second-level DC/DC conversion circuits are connected in series or in parallel.

8. The power conversion circuit according to claim 1, wherein
the first-level DC/DC conversion circuit is configured to reduce a voltage of a first port of the first-level DC/DC conversion circuit, and the second-level DC/DC conversion circuit is configured to reduce a voltage of a first port of the second-level DC/DC conversion circuit to a charging voltage required by the battery; or
the second-level DC/DC conversion circuit is configured to boost a voltage of a second port of the second-level DC/DC conversion circuit, and the first-level DC/DC conversion circuit is configured to boost a voltage of a second port of the first-level DC/DC conversion circuit and output the boosted voltage to the external device through the first end of the first-level DC/DC conversion circuit.

9. The power conversion circuit according to claim 2, wherein
the first-level DC/DC conversion circuit is configured to reduce a voltage of a first port of the first-level DC/DC conversion circuit, and the second-level DC/DC conversion circuit is configured to reduce a voltage of a first port of the second-level DC/DC conversion circuit to a charging voltage required by the battery; or
the second-level DC/DC conversion circuit is configured to boost a voltage of a second port of the second-level DC/DC conversion circuit, and the first-level DC/DC conversion circuit is configured to boost a voltage of a second port of the first-level DC/DC conversion circuit and output the boosted voltage to the external device through the first end of the first-level DC/DC conversion circuit.

10. The power conversion circuit according to claim 3, wherein
the first-level DC/DC conversion circuit is configured to reduce a voltage of a first port of the first-level DC/DC conversion circuit, and the second-level DC/DC conversion circuit is configured to reduce a voltage of a first port of the second-level DC/DC conversion circuit to a charging voltage required by the battery; or
the second-level DC/DC conversion circuit is configured to boost a voltage of a second port of the second-level DC/DC conversion circuit, and the first-level DC/DC conversion circuit is configured to boost a voltage of a second port of the first-level DC/DC conversion circuit and output the boosted voltage to the external device through the first end of the first-level DC/DC conversion circuit.

11. The power conversion circuit according to claim 4, wherein
the first-level DC/DC conversion circuit is configured to reduce a voltage of a first port of the first-level DC/DC conversion circuit, and the second-level DC/DC conversion circuit is configured to reduce a voltage of a first port of the second-level DC/DC conversion circuit to a charging voltage required by the battery; or
the second-level DC/DC conversion circuit is configured to boost a voltage of a second port of the second-level DC/DC conversion circuit, and the first-level DC/DC conversion circuit is configured to boost a voltage of a second port of the first-level DC/DC conversion circuit and output the boosted voltage to the external device through the first end of the first-level DC/DC conversion circuit.

12. The power conversion circuit according to claim 1, wherein the power conversion circuit further comprises a detection circuit, and the detection circuit is configured to detect the voltage value of the battery and the voltage values of the first capacitor and the second capacitor.

13. The power conversion circuit according to claim 1, wherein the power conversion circuit comprises two second-level DC/DC conversion circuits.

14. The power conversion circuit according to claim 1, wherein the external device is a direct current source, a load, or an energy storage converter.

15. An energy storage apparatus, comprising:
a battery,
a controller,
a first-level DC/DC conversion circuit,
a plurality of second-level DC/DC conversion circuits, and
a switching module;
a first end of the first-level DC/DC conversion circuit is configured to connect to an external device, and a second end of the first-level DC/DC conversion circuit is connected to a first end of the switching module; and a first end of each second-level DC/DC conversion circuit is connected to a second end of the switching module, and a second end of each second-level DC/DC conversion circuit is configured to connect to the battery;
one first capacitor is connected in parallel to the first-level DC/DC conversion circuit, and one second capacitor is connected in parallel to each second-level DC/DC conversion circuit; and
the controller is configured to: when a voltage of the battery is less than a first voltage threshold and voltage values of the first capacitor and the second capacitor are less than a third voltage threshold, control the switching module to be turned off or turned on, so that the plurality of second-level DC/DC conversion circuits are connected in series; or
when the voltage of the battery is greater than a second voltage threshold and the voltage values of the first capacitor and the second capacitor are less than the third voltage threshold, control the switching module to be turned off or turned on, so that the plurality of second-level DC/DC conversion circuits are connected in parallel.

16. The energy storage apparatus according to claim 15, wherein the controller is further configured to: when the voltage of the battery is less than the first voltage threshold or when the voltage of the battery is greater than the second voltage threshold, adjust a pulse width modulation (PWM) signal of the first-level DC/DC conversion circuit to reduce voltage values of the first capacitor and the second capacitor to be less than the third voltage threshold.

17. The energy storage apparatus according to claim 16, wherein the controller is further configured to: before adjusting the PWM signal of the first-level DC/DC conversion circuit, control each second-level DC/DC conversion circuit to stop operating.

18. The energy storage apparatus according to claim 16, wherein the controller is further configured to: after adjusting the PWM signal of the first-level DC/DC conversion circuit to reduce the voltage values of the first capacitor and the second capacitor to be less than the third voltage threshold, control the first-level DC/DC conversion circuit to stop operating.

19. The energy storage apparatus according to claim 18, wherein the controller is further configured to: after the first-level DC/DC conversion circuit stops operating, control the switching module to be turned off or turned on, so that the plurality of second-level DC/DC conversion circuits are connected in series or in parallel.

20. An energy storage system, comprising:
an energy storage apparatus, and
an energy storage converter; connected to the energy storage converter; and
wherein the energy storage apparatus comprises a battery, a controller, a first-level DC/DC conversion circuit, a plurality of second-level DC/DC conversion circuits, and a switching module; a first end of the first-level DC/DC conversion circuit is configured to connect to an external device, and a second end of the first-level DC/DC conversion circuit is connected to a first end of the switching module; and a first end of each second-level DC/DC conversion circuit is connected to a second end of the switching module, and a second end of each second-level DC/DC conversion circuit is configured to connect to the battery;
one first capacitor is connected in parallel to the first-level DC/DC conversion circuit, and one second capacitor is connected in parallel to each second-level DC/DC conversion circuit; and
the controller is configured to:
when a voltage of the battery is less than a first voltage threshold and voltage values of the first capacitor and the second capacitor are less than a third voltage threshold, control the switching module to be turned off or turned on, so that the plurality of second-level DC/DC conversion circuits are connected in series; or
when the voltage of the battery is greater than a second voltage threshold and the voltage values of the first capacitor and the second capacitor are less than the third voltage threshold, control the switching module to be turned off or turned on, so that the plurality of second-level DC/DC conversion circuits are connected in parallel;
the energy storage converter is configured to convert direct current energy output by the energy storage apparatus into alternating current energy and output the alternating current energy to a power grid or a load, and/or the energy storage converter is configured to convert alternating current energy output by the power grid into direct current energy and output the direct current energy to the energy storage apparatus.
